(19) United States
(12) Patent Application Publication
(10) Pub. No.: US 2009/0094043 A1
(43) Pub. Date: Apr. 9, 2009

(54) One stop full service real estate system and method

(75) Inventors: Timothy J. Leake, Rockville Centre, NY (US); Richard McQuillan, Rockville Centre, NY (US)

Correspondence Address: WEISS & WEISS;Suite 251, 300 Old Country Road, Mineola, NY, 11501, US

(73) Assignee: T&R HOLDINGS, LLC., INC.

(21) Appl. No.: 11/906,604

(22) Filed: Oct. 3, 2007

(51) Int. Cl. G06Q 10/00

(52) U.S. Cl. 705/1

(57) ABSTRACT

A system and method for providing a user with assistance in selling their home.

### FIELD OF THE INVENTION

The present invention relates to a system and method for providing a user with assistance in selling their home.

### BACKGROUND OF THE INVENTION

U.S. Patent Publn. No. 2003/0040934 relates to an integrated home inspection and home warranty system. The system directs an automated generation of a home inspection report according to home inspection information gathered from a home inspector during their inspection. The invention then subsequently creates a home warranty insurance policy based on the home inspection information.

U.S. Patent Publn. No. 2006/0155571 relates to an automated multiple order generation for vendors and creation of alerts and reminders using a single entry of walk through data. Using an existing vendor profile, vendors for respective property related tasks such as property inspection, maintenance, verification of permits are notified.

U.S. Patent Publn. No. 2007/0136081 relates to a free standing house and a method of selling homes and other products and services relating to real estate and finance using a house that includes at least one bedroom, at least one bathroom, a plurality of walls, and a full roof wherein the house is located within a structure such as a mall.

U.S. Patent Publn. No. 2007/0005378 relates to method of creating and maintaining an organized history of home inspections over time.

U.S. Patent Publn. No. 2006/0155639 relates to a method of automatically generating based on preferences of a potential borrow as entered by a third party multiple alternative loan proposals.

U.S. Patent Publn. No. 2006/0282358 relates to a method for facilitating real estate investments for formulating, managing and facilitating an investment strategy for a variety of property types and geographic markets.

U.S. Patent Publn. No. 2004/0167757 relates to a system and method for management of real estate assets via a network of various participants in real estate management. All users can track and share information on assets, use standard forms, electronically communicate and coordinate activities and transactions, and collect and analyze information regarding each activity or transaction.

U.S. Patent Publn. No. 2006/0149647 relates to a reverse purchase property transfer transaction and method of administering the same. The financial transaction comprises a contract for sale of real property in installments over a period of time with the transfer of possession and title from seller to buyer does not occur until it leaves completion of all payments.

U.S. Pat. No. 6,842,760 relates to tracking forms which allow for tracking of the completion status and implemented quality standards of a building construction project. The forms each have a quality control indicator and a completion indicator.

U.S. Pat. No. 7,143,048 relates to a method of managing a real estate property on which the lease parameters of the property are in a computer database and the file contains at least one user profile related to management of the property. The data contains information regarding the owner entity, property manager and tenant information.

U.S. Patent Publn. No. 2003/0200102 relates to a method for transferring residential property that is in need of repair and located in an economically disadvantaged neighborhood. The method involves a seller, buyer, non-profit entity and a building contractor.

U.S. Patent Publn. 2005/0071264 relates to a system and method for creating and implementing a lease agreement between a lessor of an income generating property and a lessee and preparing lease agreement documents.

U.S. Pat. No. 6,012,047 relates to a data processing system for determining an appropriate balance of credit parameters associated with the issuance of reverse equity mortgage financing.

U.S. Patent Publn. No. 2005/0267900 relates to a method and system for collecting data relating to a home. An object model is provided including a plurality of objects representing items relating to the household. A data item is received including information relating to a section of the household, and the data item is incorporated into the object model.

U.S. Patent Publn. No. 2003/0033242 relates to an automated deal processing for customers and includes promoting of the customer for at least one real parameter, such as loan amount, promoting the customer for information relating to the customer, such as income and collateral offered by the customer, accessing in real time information relating to the credit history of the customer. A plurality of origination rules are applied such as, exclusionary rules, pricing rules, risk rules and edit preference rules. A strategy is applied and an option is given.

U.S. Patent Publn. 2005/0288955 relates to a system and method of automating and stream lining real estate transactions by automatically submitting or transmitting required detailed information to companies providing real estate related services. The information is auto-populated from an electronic real estate form, a computer database, a software application or internet application used by real estate professionals.

U.S. Pat. No. 6,766,322 relates to a real estate disclosure reporting method. The patent describes the process for the full disclosure of potential detrimental positions affecting property transactions and organizes the spectrum of disclosure issues that are important to lenders and prospective buyers. The items of disclosure are classified according to condition categories.

U.S. Pat. No. 6,684,196 relates to a method and apparatus for facilitating a transaction corresponding to real property between a seller and a buyer via a network. A negotiation between the buyer and seller is facilitated via the network. Each of a plurality of real estate services relates to an aspect of the transaction and each of the plurality of real estate services is necessary for the transaction to progress.

U.S. Patent Publn. No. 2005/0010423 relates to a system for providing a single point of sale for transactions involving at least one of transfer of real estate, maintenance of real estate, improvement of real estate and selection of an ancillary service. The system comprises the user interface to allow a user to input and receive information specific to at least one of the transfer of real estate, the maintenance of real estate, the improvement of real estate and the selection of ancillary service. The user can sell real estate, purchase real estate, use a line of credit to improve the real estate and use the line of credit to purchase the ancillary service.

### SUMMARY OF THE INVENTION

The present invention relates to a one stop full service real estate system and method. The system allows a user to list real estate. The system allows a user to send in a home inspection or licensed P/E. The home inspector or P/E is paid for by the company owning the system. It is object of the present invention for the company to further pay for a termite inspection or refer the matter to a termite inspector. It is object of the present invention for the company to pay for an asbestos inspection our refer the matter to an asbestos inspector. It is object of the present invention for an inspection report to be created for the user. It is object of the present invention for the inspection report to comprise grounds, roof, exterior, attic, fireplace, chimney, foundation, electric, heating, cooling, plumbing, interior, appliance.

It is object of the present invention to provide in house license contractors based on the inspection report to make necessary repairs at minimal or no cost to the home owner, or to have the repairs made at the company's expense as a loan to be paid for at the closing. It is object of the present invention for the house to be treated for termites, where the cost for treatment is paid for by the company as a loan to be paid for at the closing. It is object of the present invention for the company to pay for asbestos removal, or the money to be loaned to the homeowner to be paid for at the closing. It is object of the present invention to provide a one year warranty for the buyer.

It is object of the present invention to generate receipts for all repairs made in the house. It is object of the present invention to prepare warranties for repairs made with reports given to the buyer.

It is object of the present invention for the company to provide a title company.

It is object of the present invention for the company to provide an attorney.

It is object of the present invention for the company to provide a financial advisor.

It is object of the present invention for the company to provide license contractors.

It is object of the present invention for the company to provide movers.

It is object of the present invention for the company to provide insurance companies for the homeowners.

It is object of the present invention for the company to provide preferred lenders and appraisers.

It is object of the present invention for the company to provide permits and certificate of occupancies.

It is object of the present invention for the company to provide home inspectors and licensed P/E.

It is an object of the present invention for the company to provide oil tank removal or filling of the oil tank.

It is an object of the present invention to provide staging for the home owner.

It is an object of the present invention to include providing furniture, paintings, floor coverings and lighting to an empty house, removing objects from a cluttered house and placing them in storage.

It is object of the present invention for the company to provide property management and care with 24 hr. service until the property is sold.

It is object of the present invention for the company to provide persons who accompany all agents and potential buyers.

It is object of the present invention for the company to provide 24 hr. service after an offer is accepted and continued until closing.

The present invention relates to a method for assisting a home owner in selling their home. A homeowner lists their home with a company. The company then contacts a home inspector or licensed engineer to inspect the home. The cost of the inspection is paid for by the company. It is a further object of the present invention for the company to also contact a termite inspector who would then inspect the home for termites. This would also be paid for by the company. It is a further object of the present invention for the company to contact an asbestos inspector. This would also be paid for by the company.

It is an object of the present invention for the home inspector or licensed engineer to generate an inspection report based on the inspection of the home. It is an object of the present invention for the inspection report to contain information comprising: grounds, roof, exterior of home, attic, fire place, chimney, foundation, electric, heating, cooling, plumbing, interior of the home, and appliances. It is an object of the present invention for the report to be given to the homeowner.

It is an object of the present invention for the company to provide contractors to the homeowner to make necessary repairs based on the inspection report, at minimal or no cost at all to the homeowner, or as a loan to the homeowner to be paid for at closing. It is an object of the present invention to provide termite treatment, if necessary, at minimal or no cost to the homeowner or as a loan to the homeowner to be paid for at closing. It is an object of the present invention to provide for asbestos removal, if necessary, at minimal or no cost to the homeowner or as a loan to the homeowner to be paid for at closing.

It is an object of the present invention for the company to provide to the buyer of the home a warranty for the repair work done. It is an object of the present invention for the warranty to be provided for a year.

It is an object of the present invention to provide receipts and warranties for all repairs made with the reports to the buyer.

It is an object of the present invention to provide the seller with the following services: title company, attorney, financial advisor, licensed contractors, home inspector or licensed engineer, movers, insurance services, preferred lenders and appraisers, permits and certificates of occupancy. If any of the costs of these services cannot be paid for by the homeowner, the company can pay for these services and recover the money at the closing.

It is an object of the present invention to provide property managers for management and care of the property until the property is sold. It is an object of the present invention to do this on a 24 hr basis.

It is an object of the present invention to send persons from the company to accompany all agents and potential buyers during inspections of the home.

It is an object of the present invention to offer the 24 hour service after the offer is accepted and until the closing.

### BRIEF DESCRIPTION OF THE DRAWING

FIG. 1 relates to a flow chart showing the method of how the system of the present invention works.

### DETAILED DESCRIPTION

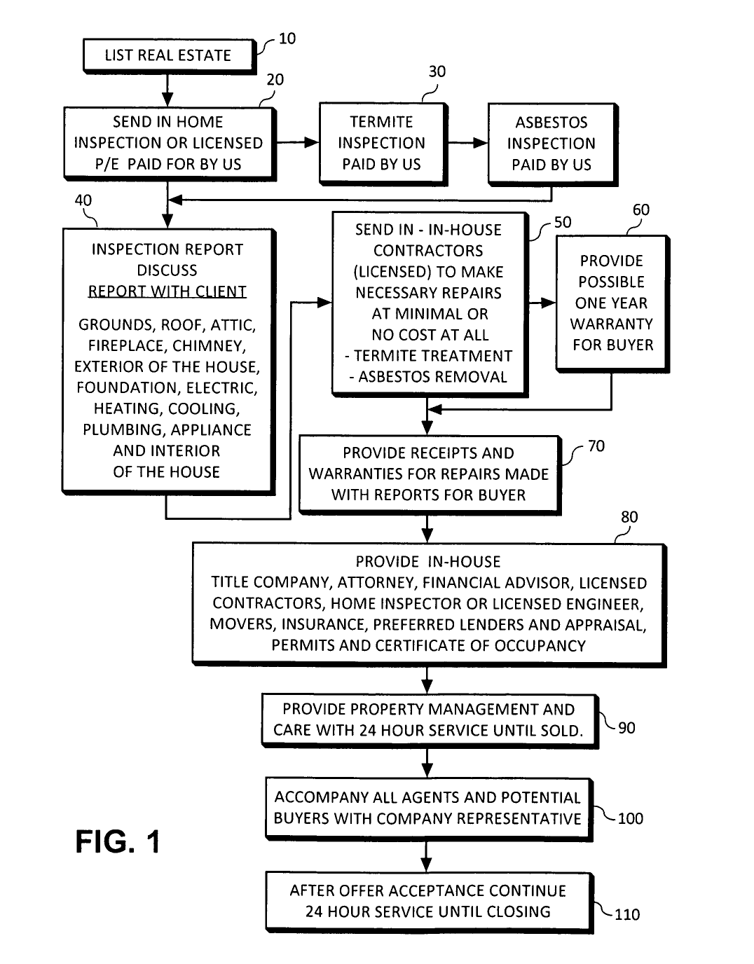

FIG. 1 shows a flow chart showing how the system and method of the present invention works in assisting a seller of a home to sell their house.

A homeowner contacts the company and lists the real estate 10 with the company. The company then sends in home inspectors or licensed engineers to the home 20 which are paid for by the company. In a preferred embodiment the company further sends to the home termite inspectors 30 which are paid for by the company.

A home inspection report 40 is created and sent to the seller. In a preferred embodiment, the home inspection report 40 includes information relating to the grounds, roof, exterior of the house, attic, fireplace, chimney, foundation, electric, heating, cooling, plumbing, interior of the house, and appliances.

The company then sends in to the home in-house contractors and/or engineers 50 to make the necessary repairs described in the inspection report 40. The repairs 50 are made at the cost of the company, or at a minimal cost, or the company can pay the expenses and then be paid back at closing. In a preferred embodiment, a termite person and an asbestos person are also sent to the home if necessary, to make the necessary treatments at the cost of the company or at minimal cost to the homeowner, or the company can pay the expenses and then be paid back at closing.

In a preferred embodiment, the company provides a 1 year warranty 60 for the buyer of the property for all items that were repaired 50.

The company provides receipts, and warranties 70 for the repairs made 50 along with the inspection report 40 to the buyer.

The company provides to the home owner the following in-house items 80: title company, attorney, financial advisor, licensed contractors, home inspector or licensed engineer, movers, insurance, preferred lenders and appraisal, and permits and certificate of occupancy.

The company provides property management and care 90 for the property until the property is sold. In a preferred embodiment, the service is provided for 24 hours/day.

The company provides a service 100 which provides persons from the company to accompany all agents and potential buyers inspecting the property.

After an offer is accepted by the seller the company offers a 24 hour full service of the property 110 until the closing.

1. A system for assisting real estate owners sell their property comprising:
a computer database for listing said property with a company;
said system informing a home inspector or licensed engineer to inspect said property;
costs for said inspection paid for by said company;
said system creating an inspection report.

2. The system of claim 1 wherein said system informs a termite inspector to inspect said property, and costs of said inspection paid for by said company.

3. The system of claim 1 wherein said system informs an asbestos inspector to inspect said property and costs of said inspection paid for by said company.

4. The system of claim 1 wherein said inspection report comprises information regarding: grounds of said property, roof, exterior of said property, attic, fireplace, chimney, foundation, electric, heating, cooling, plumbing, interior of said property, and appliances.

5. The system of claim 1 wherein said system informs licensed contractors to make necessary repairs based on the inspection report at minimal or no cost to said owner, or to have repairs made at said company's expense as a loan to be paid for at closing.

6. The system of claim 2 wherein said system informs exterminators to treat said property for termites.

7. The system of claim 2 wherein said system informs an asbestos removal company, and said company pays for said asbestos removal at said company's expense as a loan to be paid for at closing.

8. The system of claim 5 wherein said system provides a warranty to a buyer of said property for all of said repairs.

9. The system of claim 5 wherein said system generates receipts for all repairs made on said property.

10. The system of claim 5 wherein said system provides said inspection report to buyer of said property.

11. The system of claim 1 wherein said system provides a title company to said property owner.

12. The system of claim 1 wherein said system provides an attorney said property owner.

13. The system of claim 1 wherein said system provides a financial advisor to said property owner.

14. The system of claim 1 wherein said system provides license contractors to said property owner.

15. The system of claim 1 wherein said system provides movers to said property owner.

16. The system of claim 1 wherein said system provides insurance companies to said property owners.

17. The system of claim 1 wherein said system provides preferred lenders and appraisers to said property owners.

18. The system of claim 1 wherein said system provides permits and certificate of occupancies to said property owners.

19. The system of claim 1 wherein said system provides home inspectors and engineers to said property owners.

20. The system of claim 1 wherein said system provides property management and care with 24 hr. service to said property owner until the property is sold.

21. The system of claim 1 wherein said system provides persons who accompany all agents and potential buyers on inspections of said property.

22. The system of claim 1 wherein said system provides 24 hr. service after an offer is accepted and continued until closing.

23. A method for assisting a home owner in selling their home comprising:
listing a home for a homeowner;
contacting a home inspector or licensed engineer to inspect said home;
generating an inspection report based on said inspection of said home;
providing said report to said homeowner; and
providing contactors to said homeowner to make necessary repairs based on said inspection report, at minimal or no cost at all to said homeowner, or at said company's expense as a loan to be paid for at closing.

24. The method of claim 23 further comprising contacting a termite inspector to inspect said home for termites.

25. The method of claim 23 further comprising contacting an asbestos inspector to inspect said home for asbestos.

26. The method of claim 23 wherein said inspection report comprises:
information relating to: grounds, roof, exterior of home, attic, fire place, chimney, foundation, electric, heating, cooling, plumbing, interior of the home, and appliances.

27. The method of claim 23 wherein said system provides termite treatment and asbestos treatments, if necessary, at minimal or no cost to the homeowner, or at said company's expense as a loan to be paid for at closing.

28. The method of claim 23 further comprising:
providing a warranty for said repair work to a buyer of said home.

29. The method of claim 23 further comprising:
providing services to said home owner comprising: title company, attorney, financial advisor, licensed contractors, home inspector or licensed engineer, movers, insurance services, preferred lenders and appraisers, permits and certificates of occupancy.

30. The method of claim 23 further comprising:
providing property managers for management and care of said home until home is sold.

31. The method of claim 23 further comprising:
sending persons to accompany all agents and potential buyers during inspections of said home.

32. The method of claim 23 further comprising:
providing 24 hour service after offer on home is accepted and until closing.

33. The method of claim 23 further including:
providing staging personnel and equipment.
